(19) United States
(12) Patent Application Publication
(10) Pub. No.: US 2024/0370524 A1
(43) Pub. Date: Nov. 7, 2024

(54) AITKEN ACCELERATION FOR ESTIMATING ELECTRONIC STRUCTURES OF MATERIALS AND THE LIKE

(71) Applicant: International Business Machines Corporation, Armonk, NY (US)

(72) Inventors: Vasileios Kalantzis, White Plains, NY (US); Lior Horesh, North Salem, NY (US); Georgios Kollias, White Plains, NY (US); Shashanka Ubaru, Ossining, NY (US); Theodoros Salonidis, Wayne, PA (US)

(21) Appl. No.: 18/143,053

(22) Filed: May 3, 2023

(51) Int. Cl. G06F 17/16

(52) U.S. Cl. CPC G06F 17/16

(57) ABSTRACT

Using a hardware processor, load a matrix. Compute, using the hardware processor, diagonal entry approximations for the matrix by using one or more probing vectors. Apply, using the hardware processor, an Aitken extrapolation to the diagonal entry approximations. Obtain, using the hardware processor, a final diagonal estimation based on the Aitken extrapolation. Optionally, the matrix comprises a matrix of material properties of a first material, and further actions include, based on the final diagonal estimation for the first material, determining that the first material is suitable for a certain application, based on the determination that the first material is suitable, specifying the first material; and, responsive to the specifying, using the hardware processor to control a machine tool to fabricate a part of the first material.

### BACKGROUND

The present invention relates generally to the electrical, electronic and computer arts and, more particularly, to computer-aided design and manufacturing.

Computational bottlenecks are often detrimental in computational chemistry, material engineering, machine learning and other technical fields. The computational bottlenecks are also often related to large matrices, matrix multiplication, and the like. For example, computing the diagonal of a matrix may be computationally expensive and create a computational bottleneck. In a conventional approach, the diagonal of a matrix A is computed, for example, via probing. Probing can take advantage of the decay in the modulus of the off-diagonal entries of a matrix. Similarly, conventional approaches for computing trace estimates are often based on probing. However, a large number of probing vectors might be necessary to achieve a certain accuracy, leading to high computational costs.

### BRIEF SUMMARY

Principles of the invention provide systems and techniques for Aitken acceleration for estimating electronic structures of materials and the like. In one aspect, an exemplary method includes the operations of loading, using a hardware processor, a matrix; computing, using the hardware processor, diagonal entry approximations for the matrix by using one or more probing vectors; applying, using the hardware processor, an Aitken extrapolation to the diagonal entry approximations; and obtaining, using the hardware processor, a final diagonal estimation based on the Aitken extrapolation. This aspect advantageously improves the technological process of computerized matrix diagonal estimation for a variety of practical applications, by reducing the number of central processing unit (CPU) cycles to determine a matrix diagonal estimation.

Optionally, in the loading step, the matrix is a matrix of material properties of a first material, and a further step includes, based on the final diagonal estimation for the first material, determining that the first material is unsuitable for an application.

Optionally, based on the determination that the first material is unsuitable, reformulate the first material as a second, different material and repeat the loading, computing, applying, and obtaining steps for the second material; based on the final diagonal estimation for the second material, determine that the second material is suitable; and, based on the determination that the second material is suitable, specify the second material.

Optionally, responsive to the specifying, use the hardware processor to control a machine tool to fabricate a part of the second material.

Advantageously, one or more of these optional steps alleviate the high computational costs of estimating electronic structures of materials, accelerate an important computational bottleneck in computational chemistry, material engineering, or machine learning; and/or enable rapid, accurate analysis and specification of materials with computer aided-design, reducing the need for physical testing/prototyping.

In one aspect, a computer program product comprises one or more tangible computer-readable storage media and program instructions stored on at least one of the one or more tangible computer-readable storage media, the program instructions executable by a processor, the program instructions comprising loading, using the processor, a matrix; computing, using the processor, diagonal entry approximations for the matrix by using one or more probing vectors; applying, using the processor, an Aitken extrapolation to the diagonal entry approximations; and obtaining, using the processor, a final diagonal estimation based on the Aitken extrapolation.

In one aspect, an apparatus comprises a memory and at least one processor, coupled to the memory, and operative to perform operations comprising loading a matrix; computing diagonal entry approximations for the matrix by using one or more probing vectors; applying an Aitken extrapolation to the diagonal entry approximations; and obtaining a final diagonal estimation based on the Aitken extrapolation.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by a computer numerical control (CNC) machine, by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improving the technological process of computerized computations by accelerating matrix operations;
improving the performance of a computer itself via reducing central processing unit cycles and/or memory resources, and/or reduced processing time for performing matrix operations;
an Aitken's acceleration method that, for example, alleviates the high computational costs of estimating electronic structures of materials;
an Aitken's acceleration method that, for example, alleviates the high computational costs of providing trace estimates;
acceleration of an important computational bottleneck in computational chemistry, material engineering, machine learning, and the like;
efficient estimation of the centrality of a network through the diagonal entries of the Laplacian matrix of a graph (for example, a graph of a social media network);
reduced memory requirements because fewer probing samples are needed; and
acceleration of learning tasks in artificial intelligence (AI).

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 illustrates four matrices having different densities;

FIG. 2 is a flowchart for an example method for matrix diagonal estimation, in accordance with an example embodiment;

FIGS. 3A-3B are graphs showing the relative error vs. the number of vectors in the original sequence for two examples of probing, in accordance with an example embodiment;

FIG. 3C is a graph showing the relative error vs. the number of vectors in the original sequence for a third example of probing, in accordance with an example embodiment;

FIGS. 4A-4B are graphs showing the relative error vs. the number of vectors in the original sequence for two examples of probing, in accordance with an example embodiment;

FIG. 5 shows a plot of the relative error achieved as the number of sample vectors increase, in accordance with an example embodiment;

FIG. 6 shows plots of the same quantities as in FIG. 5 for a Matérn covariance kernel, in accordance with example embodiments;

FIG. 7 depicts a computing environment according to an embodiment of the present invention; and

FIG. 8 is a high-level block diagram of software controlling a CNC machine, in accordance with example embodiments.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

### The Problem of Matrix Diagonal Estimation

The physical and chemical properties of materials are largely determined by the electronic structure of the atoms and molecules found within them. Traditional methods for electronic structure computations are based on the solution of generalized eigenvalue problems (“diagonalization”) for a sequence of large Hermitian matrices, known as one-particle Hamiltonians (the matrices are diagonalized). The computational cost of this approach scales cubically in the size n of the problem (that is, the size of the input). In the last two decades, a number of approaches have been developed that are capable, in many cases, of achieving “optimal” computational complexity. These methods, often referred to as “O(n) methods,” apply mostly to insulators. They avoid diagonalization by instead computing the density matrix, a matrix which encodes all the important physical properties of the system.

### Off-Diagonal Decay

For example, for insulators at zero temperature, a density-based method is the spectral projector onto the invariant subspace associated with the eigenvalues of the Hamiltonian falling below a certain value. For systems at positive temperatures, the density matrix can be expressed as a smooth function of the Hamiltonian, which can lead to a smooth off-diagonal decay of the entries. This is advantageous for a number of example embodiments. The possibility of developing such methods rests on a deep property of electronic matter, called “nearsightedness.” The “Nearsightedness Principle” expresses the fact that, for a large class of systems, the effects of disturbances, or perturbations, remain localized and thus do not propagate beyond a certain (finite) range; in other words, far away parts of the system do not “see” each other. Mathematically, this property translates into rapid off-diagonal decay in the density matrix.

### Green's Function

Dynamic Mean-Field Theory (DMFT) has recently emerged as an important tool in the investigation of lattice models of highly correlated electrons in a quantum many-body system. For the inhomogeneous DMFT method, the computation of the diagonal of the inverse of a large collection of sparse matrices is required. For the imaginary time Green's function, the discretized matrix is often diagonally dominant and positive-definite. Consequently, the matrix inverse, which is denoted by A, shows an exponential decay property, so that many entries are small.

As described above, in a conventional standard approach, the diagonal of A is computed via probing, which works well for sparse matrices as well as matrices with off-diagonal decay. Probing computes increasingly accurate estimates with each iteration and can take advantage of the decay in the modulus of the off-diagonal entries; however, a large number of probing vectors might be necessary to achieve a certain accuracy, leading to high computational costs. (For example, the first estimate uses one vector, the second estimate uses two vectors, the third estimate uses four vectors, and so on.) Example embodiments recognize and show that probing techniques are linearly converging. Theoretical results show that example embodiments accelerate the convergence and recognize and show that, therefore, the Aitken extrapolation can be used to accelerate the convergence. In one example embodiment, an Aitken's acceleration method alleviates, for example, the high computational costs to compute the diagonal of A. Essentially, the first n estimates of probing are combined to provide a more accurate estimate for relatively comparable computing resources.

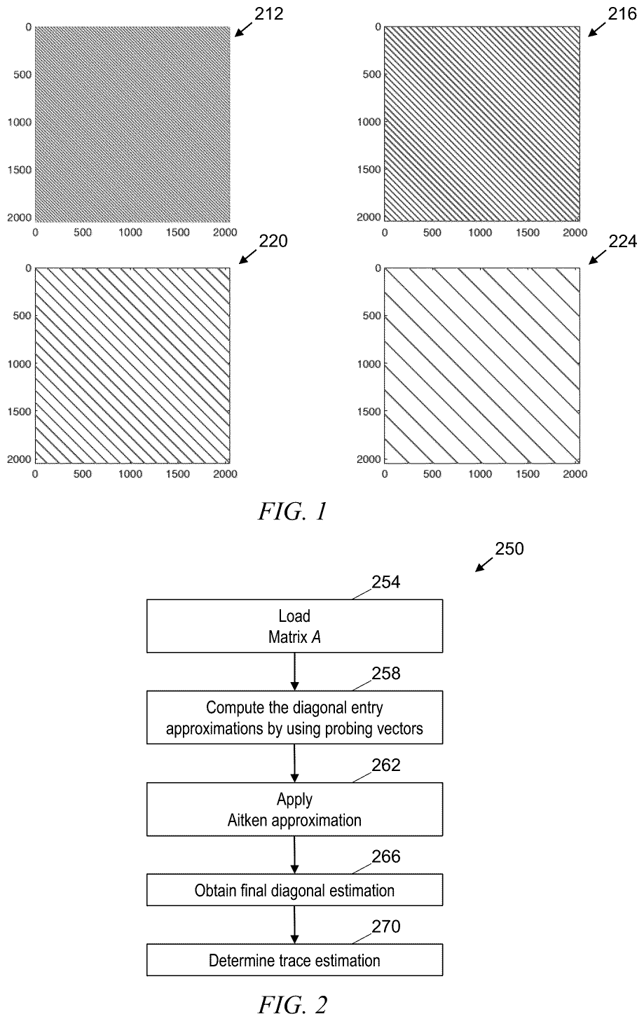

FIG. 1 illustrates four matrices having different densities. As illustrated in FIG. 1, matrix 212 has the greatest number of non-zero diagonals, matrix 216 has a fewer number of non-zero diagonals, matrix 220 has the second least number of non-zero diagonals, and matrix 224 has the least of non-zero diagonals. If non-zero values exist only along the main diagonal, all diagonal entries can be computed with one matrix-vector multiplication (to get one vector that contains the diagonal entries). As the number of diagonals with non-zero entries increases, the number of vectors used with the matrix-vector multiplication can be increased to isolate the main diagonal; that is, multiply A with the columns of the identity matrix of the same size and extract the diagonal entries, one at a time. The sparser the matrix, the fewer the number of probing vectors needed. Many matrices under consideration are generally not sparse.

Trace Estimation of Matrices with Decaying Off-Diagonal Entries

The simplest approach is to compute the n diagonal entries eᵢ^{T}Aeᵢ, i=1, . . . , n, at the cost of n Matrix-Vector products (MVs).

Let V∈{0, 1}^{n×s} matrix. The diagonal can be estimated as diag ([(A∘VV^{T})]Ø[(V∘V)]).

The entry A_{i,j} will contribute to the approximation of diag (A) if and only if the i^{th} row of V is non-orthogonal to the j^{th} row of V. If A has decaying off-diagonal entries, then only “errors” from (anti-) diagonals located far from the main diagonal are allowed. In practice, s=1, . . . , n is scanned and the scanning is stopped when the obtained approximation is accurate enough, such as exhibiting an accuracy that meets a specified accuracy of a given application. For example, once the largest entries on the diagonal and the most influential vertices in the network are identified, the scanning may be stopped. The skilled artisan can use heuristics to determine a required level of accuracy based on the domain of the application utilizing the results. In one or more example embodiments, the set of diagonal estimates is treated as a convergent sequence (such as n independent sequences where n is the size of the matrix). If possible, an Aitken extrapolation can be applied to the sequence, and the Aitken extrapolation can possibly be iteratively applied to the resulting accelerated sequence.

Matrix Entries Contributing to Diagonal Estimation as s Increases (Such as for n=2,048)

### Aitken's δ-Squared Process, Sequence Acceleration:

Aitken's extrapolation is a technique used for accelerating the convergence of linearly convergent sequences. Given a linearly convergent sequence X=(xₙ)_{n∈N}, a new sequence is created:

$$\hat{X} := {\hat{x}}_{n} = {x}_{n + 1} - \frac{{( {x}_{n + 2} - {x}_{n + 1} )}^{2}}{( {x}_{n + 2} - {x}_{n + 1} ) - ( {x}_{n + 1} - {z}_{n} )}$$

Aitken's extrapolation can lead to a sequence \hat{X} which converges faster to the limit of X. The diagonal estimation problem involves computing the i^{th} diagonal entry of A, by setting x₁, x₂, . . . , equal to the i^{th} diagonal entry approximation obtained using 1, 2, . . . , probing vectors. As described further below, it is recognized herein that Aitken's extrapolation may be applied to diagonal estimates and trace estimates. To determine whether Aitken's sequence acceleration is appropriate, one or more embodiments test whether the ratio (xᵢ₊₁−xᵢ)/(xᵢ−xᵢ₋₁) is constant for all n diagonal entries and iteration index i up to which the diagonal estimation procedure set forth immediately below has executed already. A large number of floating-point operations can then be saved.

### Diagonal Estimation Procedure

In one example embodiment, a diagonal estimation procedure is defined as:

```
For i = 1, ... , log(n)
  k = 2ⁱ − 2ⁱ⁻¹
  V = repmat(Iₖ, n/k , 1) %%Iₖ is the k × k identity matrix
  For j = 1, ... , n: dⱼ(i) = (V^{T} AV)_{j,j}
  For j = 1, ... , n: Apply (repeated) Aitken acceleration to dⱼ
  If all n diagonal entries are computed to machine precision, exit;
End
Return diag(A) = [d₁, ... , dₙ]
```

where I is the identity matrix and d is the diagonal estimate of the matrix.

The above diagonal estimation procedure considers at most log (n) iterations, where the i^{th} iteration defines a scalar k, a matrix V, and an approximation d(i) of the true diagonal of the matrix A. The approximation d(i) is formed by element-wise multiplication of the matrix A with the matrix (VV^{T}), followed by element-wise division with the matrix V∘V. The procedure terminates before log (n) iterations are performed if the progress made by Aitken acceleration stagnates.

The cost during the i^{th} step is: 2ⁱ⁻¹ new matrix-vector products with matrix A. For V:=columns of a Hadamard matrix, previous matrix-vector products can be re-used. As noted above, Aitken acceleration can be applied on the already accelerated sequence (referred to as “Aitken-2”, or double Aitken, herein). It is generally preferable to terminate the procedure when the trace stabilizes (as is done in the experiments described below).

FIG. 2 is a flowchart for an example method 250 for matrix diagonal estimation, in accordance with an example embodiment. In one example embodiment, a matrix A is loaded (operation 254). The diagonal entry approximations are computed by using, for example, 2ⁱ, i=1, 2, . . . , probing vectors (operation 258). An Aitken extrapolation is applied (operation 262) and the final diagonal estimation is obtained (operation 266). In one example embodiment, a trace estimate is determined based on the final diagonal estimation (operation 270). It is noted that it is not required to have the whole matrix available for processing; only a portion of the matrix needed for matrix-vector multiplication is required. It is also noted that the example method of FIG. 2 may be performed by software executing on a general-purpose computer, software executing on one or more graphical processing units (GPUs), with the aid of a hardware accelerator, in firmware or hardware (e.g., in an application-specific integrated circuit (ASIC) or field-programmable gate array (FPGA)), or generally, using any machine capable of performing matrix-vector multiplication.

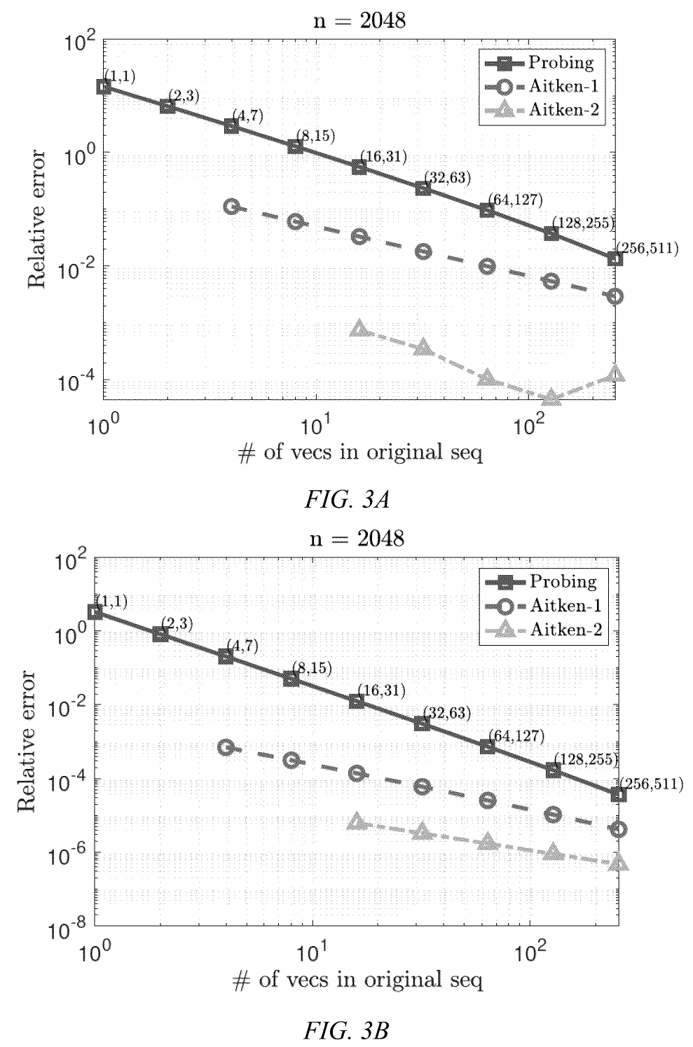

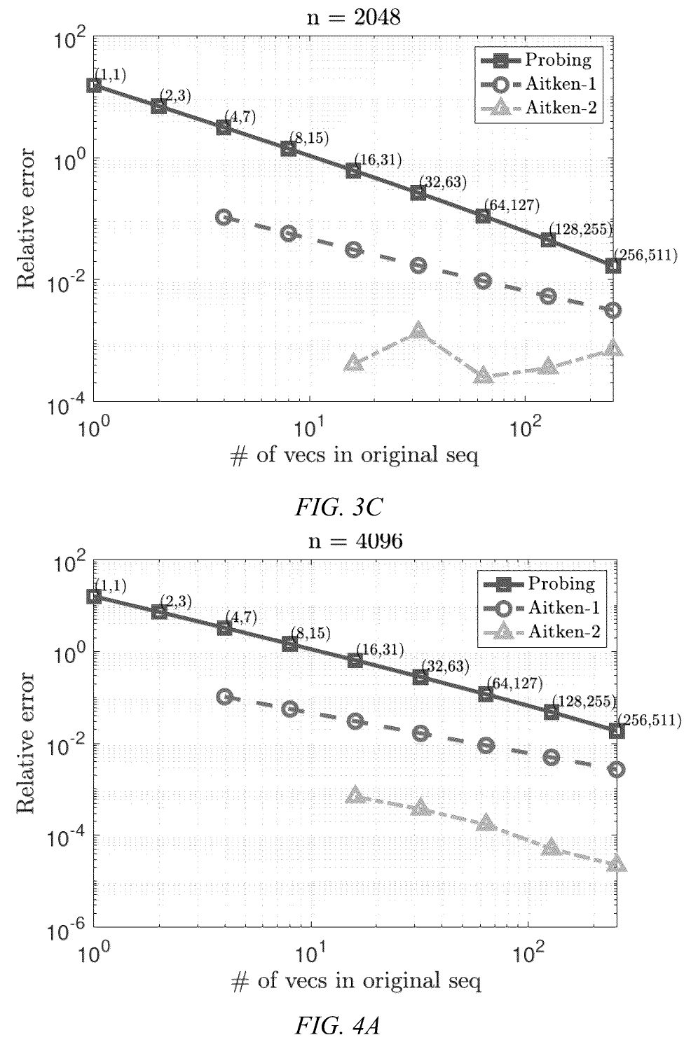

FIGS. 3A-3B are graphs showing the relative error vs. the number of vectors in the original sequence for two examples of probing, in accordance with an example embodiment. In the example of FIG. 3A, Aᵢᵢ=1, Aᵢⱼ=1/|i−j|(i≠j). In the example of FIG. 3B, Aᵢᵢ=1, Aᵢⱼ=1/|i−j|² (i≠j). It is noted that, the higher the diagonal decay, the better the performance accelerating the probing. As illustrated in the graphs of FIGS. 3A and 3B, as the number of vectors increases (the first number in the parentheses) and the number of matrix-vector multiplications increases (the second number in the parentheses), the accuracy improves in an approximately linear manner (the straight line demonstrates the linear convergence). Once three probing estimates are available, an Aitken approximation may be determined. In addition, as additional probing estimates become available, the Aitken approximation may be recalculated. As illustrated in FIGS. 3A and 3B, the Aitken approximation will typically achieve a given accuracy faster than the simple probing procedure (unless probing is able to achieve the accuracy with, for example, four or fewer vectors, in which case performance of probing alone will suffice). In addition, for any given number of vectors of four or more, the Aitken approximation will achieve a greater accuracy than the simple probing procedure.

FIG. 3C is a graph showing the relative error vs. the number of vectors in the original sequence for a third example of probing, in accordance with an example embodiment. In the example of FIG. 3C, noise has been added and Aᵢᵢ=1,

$$\\ {A}_{ij} = \frac{1}{\vert i - j \vert} ( i \neq j ) + O ( 1 e - 3 ) .$$

As illustrated in the graph of FIG. 3C, as the number of vectors increases and the number of matrix-vector multiplications increases, the accuracy improves in an approximately linear manner. Once three probing estimates are available, an Aitken approximation may be determined. In addition, as additional probing estimates become available, the Aitken approximation may be recalculated. As illustrated in FIG. 3C, the Aitken approximation will typically achieve a given accuracy faster than the simple probing procedure (unless probing is able to achieve the accuracy with four or fewer vectors). In addition, for any given number of vectors of four or more, the Aitken approximation will achieve a greater accuracy than the simple probing procedure.

Also, as illustrated in the graph of FIG. 3C, Double Aitken is not guaranteed to be linear since single Aitken is not guaranteed to be linearly converging. Also, Double Aitken is not guaranteed to perform better than Aitken. As illustrated in FIG. 3C, it is apparent that the Double Aitken results are not linear. In the example of FIG. 3C, the diagonal decay was not fast enough for probing to generate estimates that could fit in a sufficiently linearly converging sequence. It is noted that, depending on the accuracy needed, probing may be ceased before Double Aitken is available for computation.

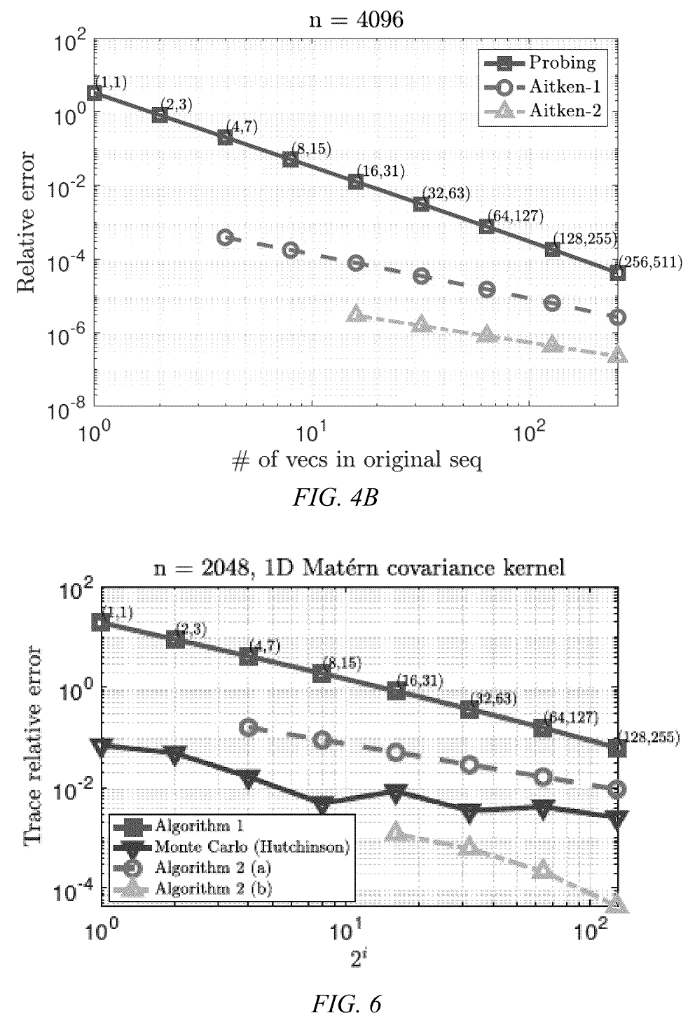

FIGS. 4A-4B are graphs showing the relative error vs. the number of vectors in the original sequence for two examples of probing, in accordance with an example embodiment. In the example of FIG. 4A,

$$\\ {A}_{ii} = 1 , {A}_{ij} = \frac{1}{\vert i - j \vert} ( i \neq j ) .$$

In the example of FIG. 4B, Aᵢᵢ=1,

$$\\ {A}_{ij} = \frac{1}{{\vert i - j \vert}^{2}} ( i \neq j ) .$$

As illustrated in FIGS. 4A and 4B, the Aitken approximation will typically achieve a given accuracy faster than the simple probing procedure (unless probing is able to achieve the accuracy with four or fewer vectors). In addition, for any given number of vectors of four or more, the Aitken approximation will achieve a greater accuracy than the simple probing procedure. Also, as illustrated in FIG. 4A, the double Aitken results can provide a significant improvement compared to both probing and single Aitken.

### Practical Applications

The estimation technique described above may be used in a variety of practical applications. For example, physicists often need to determine if an alloy will remain an alloy at higher temperatures. This requires determining how much energy is needed to excite an electron from one energy level to another energy level and determining how big the gap is. If the gap is too large, the compound is stable; if it's not large enough, the compound is not stable. If the compound is not stable, the alloy may be reformulated (such as by using different percentages of different metals), retested, and utilized in a manufacturing process. In another example, a large gap in energy levels may be indicative of a good insulator.

More generally, in density functional theory, at finite temperature, the electronic structure of a given system (such as metals or other chemical compounds) is completely determined by its density matrix, which is represented by Fermi operators. The diagonal elements of this matrix in real space are called electronic density profile, and quantifies important concepts such as chemical bonds, electron energy levels, and the like. Using the electronic density profile, different chemical properties of the system can be estimated, such as the strength of chemical bonds, the energy required to excite electrons, and the like.

The trace of this matrix is another important quantity of electronic structure analysis and is called the electronic energy. This defines the potential energy surface for nuclei and plays a central role in ab initio quantum chemistry. As described above, if a compound is determined to be unstable, the alloy may be reformulated (such as by using different percentages of different metals), retested, and utilized in a manufacturing process. It is noted that the skilled artisan would recognize that an alloy would be unstable under certain conditions, such as those likely to be encountered in the field (e.g., a certain temperature or range of temperatures), and similarly for insulation properties (electrical or thermal). The skilled artisan, given the teachings herein, will be able to determine when a material such as an alloy, nominal insulator, etc. is suitable. For example, an alloy may be unsuitable when it is no longer an alloy in a certain temperature range or over a certain temperature; to be suitable, a nominal electrical insulator may need to have an electrical resistivity that is greater than a threshold value or an electrical conductivity that is less than a threshold value; to be suitable, a nominal thermal insulator may need to have a thermal resistivity that is greater than a threshold value or a thermal conductivity that is less than a threshold value. The skilled artisan can heuristically apply knowledge of service conditions to be encountered, given the teachings herein.

### Trace Estimation

In one example embodiment, a method is provided to estimate the trace of symmetric matrices that are available only via matrix-vector multiplication. The exemplary method constructs a series of trace estimates by applying a probing technique with an increasing number of vectors. These estimates are then treated as a converging sequence whose limit is the sought matrix trace, and the Aitken's 42 process is applied to accelerate its convergence to the trace limit. Numerical experiments performed on covariance matrices demonstrate the competitiveness of the example embodiments versus probing and randomized trace estimators.

Computing the sum of the diagonal elements (trace) of an n×n symmetric matrix A is an important computational task that arises in a wide range of scientific applications, including uncertainty quantification, lattice quantum chromodynamics, network theory, and protein folding. In addition, several machine learning applications require the computation of the trace of covariance matrices. For example, the Fréchet Inception Distance (FID), a performance metric to evaluate the quality of Generalized Adversarial Networks, requires the computation of the trace of sample co-variance matrices associated with distributions of real and engineered datasets. Similarly, the trace estimation of precision matrices appears when fitting the Matérn covariance model to a Gaussian process via maximum likelihood estimation. Finally, computing the trace of covariance matrices allows the quantification of the total variance of the underlying data-collection.

In example embodiments, scenarios where A is implicitly-defined i.e., A is not formed explicitly but Matrix-Vector (MV) products of the form y=Az, z∈ [symbol] ⁿ can be computed. For example, let

$$\\ A = \frac{1}{n} {XX}^{{}_{} {}_{} T}$$

denote the sample covariance matrix associated with the matrix X containing n observed data of dimension p. Forming the matrix A explicitly requires the storage of n² scalars and 2pn² floating-point operations, which becomes impractical for large data-collections. On the other hand, MV products with A can be computed through computing MV products with the matrices X and X^{T}.

The simplest approach to compute the trace tr(A) of the matrix A is to compute each individual diagonal entry individually, i.e., tr(A)=Σⱼ₌₁^{j=n}eⱼ^{T}Aeⱼ, where eⱼ ∈ [symbol] ⁿ denotes the j^{th} column of the n×n identity matrix. This approach requires n MV products with matrix A and becomes impractical for anything but very small matrix size n.

Instead, practical algorithms settle for an approximation of the form tr(A)≈σΣⱼ₌₁^{j=k}aⱼ^{T}Azⱼ, σ=0 where the entries of the n-dimensional vectors {zⱼ}ⱼ₌₁^{j=k} HET are chosen either randomly or deterministically. For example, when each entry of zⱼ is ±1 with equal probability (i.e., Rademacher vector) and σ=1/k, the above Monte Carlo (MC) trace estimator is a minimum variance unbiased estimator of tr(A), and a minimum variance (over the field of real random vectors) unbiased estimator of tr(A), and converges as O(1/\sqrt{k}). Standard MC approaches do not take under consideration any special properties of matrix A, e.g., decay in the magnitude of the off-diagonal entries. An alternative to random vectors is to se t the vectors {zⱼ }ⱼ₌₁^{j=k} as columns of the Hadamard matrix of the appropriate size or as linear combinations of the n×n identity matrix. This choice of vectors has the property that the error in the approximation of tr(A) only comes from certain non-zero entries, e.g., those located on diagonals which are multiple of k. Such procedures are referred to as probing. A well-known limitation of probing versus MC estimators is the discarding of all previous computational efforts every time a new approximation of tr(A) is computed. This has been studied in the prior art and it was suggested to use hierarchical probing.

An exemplary algorithm alleviates the incremental nature of probing by applying a series transformation process. In particular, under the assumption that the estimates χ₀, χ₁, . . . , produced by the probing trace estimator converge (approximately) linearly to tr(A), the former can be treated as part of a convergent sequence which is accelerated by transforming it to another sequence which has the same limit (i.e., tr(A)), but converges to it at a super-linear rate. This is a series acceleration problem, and the algorithm disclosed accelerates the sequence χ₀, χ₁, . . . , by applying Aitken's delta-squared (Δ²) process. Aitken's extrapolation method has been considered previously in the context of estimating the trace of the matrix inverse by extrapolating the pre-diction of the moment x^{T}A⁻¹x. Nonetheless, the latter work is quite different than the exemplary algorithm disclosed herein, as no moment extrapolation is performed; rather, Aitken's Δ² process is applied to a sequence of trace estimates obtained by a probing trace estimator.

Without loss of generality, the size of matrix A is assumed below to satisfy n=2^{j} for some j∈N. Lowercase bold letters, x, will denote vectors, while uppercase bold letters, X, will represent matrices.

### Approximating Tr(A) by Probing

Definition 1. For any integer 0≤i≤logₛ(n), define the integer variable

kᵢ=2ⁱ,

where log₂ denotes the binary logarithm. The approximation χᵢ of tr(A) is then defined as:

$$\\ {χ}_{i} = {\sum }_{j = 1}^{j = {k}_{i}} {z}_{j}^{{}_{} T} {Az}_{j} ,$$

where all entries of zⱼ∈ [symbol] ⁿ are equal to zero except for those indexed by (i−1)kᵢ+j

$$\\ i = 1 , … , \frac{n}{{k}_{i}} ,$$

which are equal to one.

The matrix whose jth column is equal to zⱼ,j=1, . . . , zₖ_{ᵢ} is denoted by Zₖ_{ᵢ}=[z₁, . . . , zₖ_{ᵢ}]. For example, let n=4. The matrices Z₁, Z₂, and Z₄ are equal to

$$\\ {Z}_{1} = ( \begin{matrix}1 \\ 1 \\ 1 \\ 1\end{matrix} ) , {Z}_{2} = ( \begin{matrix}1 & 0 \\ 0 & 1 \\ 1 & 0 \\ 0 & 1\end{matrix} ) , and {Z}_{4} = ( \begin{matrix}1 & 0 & 0 & 0 \\ 0 & 1 & 0 & 0 \\ 0 & 0 & 1 & 0 \\ 0 & 0 & 0 & 1\end{matrix} ) ,$$

respectively.

Let the sum of the entries of the η^{th} super-diagonal of A be denoted by ε_{η}=Σₚ₌₁^{p=n-η}A_{p,η+p}. The estimation χᵢ of tr(A) can be written as:

χᵢ=tr(Zₖ_{ᵢ}^{T}AZₖ_{ᵢ})

$$\\ \begin{matrix}= tr ( A ) + 2 ( {ε}_{{k}_{i}} + {ε}_{2 {k}_{i}} + … ) = tr ( A ) \text{+} {\sum }_{j = 1}^{j = ( n / {k}_{i} ) - 1} 2 {ε}_{{jk}_{i}} & ( 1 )\end{matrix}$$

Therefore, the error in the approximation of the tr(A) by the estimate χᵢ=Σⱼ₌₁^{j=k}^{ᵢ}Zₖ_{ᵢ}^{T}Azⱼ stems only from those hyper-diagonals whose index is a multiple of the integer 2ⁱ. Moreover, the hyper-diagonals which contribute to the approximation error of the estimate χᵢ are a super-set of those hyper-diagonals which contribute to the approximation error of the estimate χᵢ₊₁.

Proposition 1. Let the entries of matrix A be finite and assume that its off-diagonal entries have the same sign. Then, the sequence χ₀, χ₁, . . . , converges monotonically to tr(A).

Proof. Since A has finite entries, the sequence χ₀, χ₁, . . . , is bounded. Following (1), the hyper-diagonals which contribute to the approximation error of the estimate χᵢ are a super-set of the hyper-diagonals which contribute to the approximation error of the estimate χᵢ₊₁. Since Zₖ_{ᵢ} has only non-negative entries and the off-diagonal entries of A have the same sign, it follows that the sequence χ₀, χ₁, . . . is either non-increasing or non-decreasing, and converges to tr(A).

Matrices whose off-diagonal entries satisfy the above properties can be found in the numerical experiments below as well as numerous references.

The probing procedure is summarized in Trace Algorithm 1. The procedure terminates when the relative difference between the two most recent trace approximations is below an acceptable threshold ϵ∈ [symbol] . Notice that Trace Algorithm 1 terminates after at most log₂(n) iterations, i.e., χlog₂(n) is the exact trace since Zₙ is equal to the n×n identity matrix. The probing estimate χᵢ of tr(A) requires the summation of kᵢ scalar (dot) products between zⱼ^{T} and yᵢ=Azⱼ, j=1, . . . , kᵢ. Assuming that the probing trace estimator converges with χᵢ as the latest estimation of tr(A), Trace Algorithm 1 requires 2⁰+2¹+ . . . +2ⁱ=2ⁱ⁺¹−1 MV products of the form y=Az, z∈ [symbol] ⁿ.

### Algorithm 1: Probing Trace Estimator

1. Compute χ₀=1^{T}A1, where 1∈ [symbol] ⁿ is the vector of all ones. Set i=0 and a tolerance ϵ∈(0,1).
   do
      2. Set i=i+1,kᵢ=2ⁱ
      3. Compute χᵢ=tr(Zₖ_{ᵢ}^{T} AZₖ_{ᵢ})
   while |χᵢ−χᵢ₋₁|>ϵχᵢ and i≤log₂n

Following the above discussion, it becomes evident that computing the probing estimate χᵢ₊₁ requires as much work as computing all previous i probing terms together. (A more efficient implementation is possible if partial MV products are stored in memory.) Therefore, the computation of each progressive term becomes increasingly more expensive. As a remedy, the use of sequence acceleration techniques is considered below in order to reduce the computational cost of Trace Algorithm 1.

### Accelerating Probing Trace Estimators by Aitken's Δ² Process

In one example embodiment, a sequence acceleration technique accelerates the convergence rate of probing matrix trace estimators. The idea behind sequence acceleration techniques is to transform a slowly convergent sequence {tₙ}_{n∈N} into a new sequence {\hat{t}ₙ}_{n∈N} which converges to the same limit faster than the original sequence. (Note that {tₙ}_{n∈N} can also be non-scalars, e.g., vectors, matrices, or tensors.)

The literature on sequence acceleration techniques spans several centuries, but research on the topic was revived during the initial era of digital computers due to Wynn's Epsilon Method. Richardson's extrapolation method and Aitken's A² process are among the most well-known extrapolation-based methods used for accelerating the rate of linearly converging sequences.

Definition 2. A convergent sequence {tᵢ}ᵢ₌₀^{∞} converges linearly, with rate μ∈(0, 1), when

$$\\ {lim}_{i \to ∞} \frac{\vert {t}_{i + 1} - {t}^{{}_{} *} \vert}{\vert {t}_{i} - {t}^{{}_{} *} \vert} = μ$$

Unlike Richardson extrapolation, Aitken's Δ² process can be applied even when the rate of convergence is unknown, since the latter does not appear in the update of \hat{t}ₗ. For this reason, in one example embodiment, focus is exclusively on Aitken's Δ² process.

Definition 3. Given a sequence {tᵢ}ᵢ₌₀^{∞}, Aitken's A² process generates a new sequence {\hat{t}ₗ}ᵢ₌₀^{∞} such that

$$\\ = {t}_{i} = \frac{{( {t}_{i + 1} - {t}_{i} )}^{2}}{{t}_{i + 2} - 2 {t}_{i + 1} + {t}_{i}} = {t}_{i} - \frac{{( {t}_{i + 1} - {t}_{i} )}^{2}}{( {t}_{i + 2} - {t}_{i + 1} ) - ( {t}_{i + 1} - {t}_{i} )}$$

Under the assumption that {tᵢ}ᵢ₌₀^{∞} converges linearly to a limit t* and that, for i sufficiently large, (tᵢ₊₁−t*)(tᵢ−t*)≥0, the sequence {\hat{t}ₗ}ᵢ₌₀^{∞}, generated by Aitken's Δ² process, converges to t* faster in the sense that

$$\\ {lim}_{i \to ∞} \frac{- {t}^{{}_{} *}}{{t}_{i} - {t}^{{}_{} *}} = 0$$

Although Aitken's Δ² process does not generally converge quadratically, it is noted that, when the terms {tᵢ}ᵢ₌₀^{∞} come from a fixed point procedure, i.e., tᵢ₊₁=f(tᵢ) for some function f: [symbol] → [symbol] which converges to a fixed point, the convergence rate can be shown to be quadratic. This process is known as Steffensen's method.

The algorithm presented herein applies Aitken's Δ² process to the sequence formed by the estimates χ₀, χ1, . . . , obtained by Trace Algorithm 1. Let now kᵢ=2ⁱ and i+1≤log₂(n). The rate of convergence of the estimates {χᵢ}ᵢ₌₀^{i=log}^{₂}⁽ⁿ⁾ is linear with a rate μ∈(0,1) if

$$\\ \frac{\vert {χ}_{i + 1} - tr ( A ) \vert}{\vert {χ}_{i} - tr ( A ) \vert} = \frac{{\sum }_{j = 1}^{j = ( n / 2 {k}_{i} ) - 1} {ε}_{2 {jk}_{i}}}{{\sum }_{j = 1}^{j = ( n / {k}_{i} ) - 1} {ε}_{{jk}_{i}}} = μ .$$

In practice, the sequence χ₀, χ₁, . . . can be accelerated even when the above ratios are only approximately equal.

Algorithm 2: Aitken's Δ² accelerated trace estimator
1. Set χ₋₁=0, χ₀=1^{T}A1, χ₁=tr(Z₂^{T}AZ₂), and i=−1. Set a tolerance ϵ∈(0, 1).
   do
      2. Set i=i+1, kᵢ₊₂=2ⁱ⁺²
      3. Compute χᵢ₊₂=tr(Zₖ_{ᵢ₊₂}^{T}AZₖ_{ᵢ₊₂})
      4. Set

$$\\ {\hat{χ}}_{i} = {χ}_{i} - Trace Algorithm 1 \frac{{( {χ}_{i + 1} - {χ}_{i} )}^{2}}{( {χ}_{i + 2} - {χ}_{i + 1} ) - ( {χ}_{i + 1} - {χ}_{i} )}$$

while |\hat{χ}ᵢ−\hat{χ}ᵢ₋₁|>ϵ\hat{χ}ᵢ, \hat{χ}ᵢ≠χᵢ₋₁, and i≤log₂(n)−2

The method is listed in Trace Algorithm 2. By construction, Trace Algorithm 2 terminates after at most log₂(n)−2 iterations. Compared to Trace Algorithm 1, the cost to obtain the estimates \hat{χ}₀, χ₁, . . . , \hat{χ}ᵢ₋₂ is roughly equal to that of obtaining χ₀, χ₁, . . . , χᵢ and thus Trace Algorithm 2 will be cost-effective compared to Trace Algorithm 1 if and only if \hat{χ}ᵢ₋₂ is a better approximation of tr(A) compared to \hat{χ}ᵢ. (The additional work needed to compute \hat{χ}₀, χ₁, . . . , \hat{χ}ᵢ₋₂ requires only the calculation of four differences, one multiplication, and one division between scalars.) While Aitken's Δ² process breaks down if the sequence of first differences has a repeating term, this is not the case with Trace Algorithm 2 since it terminates as soon as successive probing estimates χᵢ and χᵢ₊₁ become numerically equal. Note also that the trace estimates \hat{χ}₀. \hat{χ}₁, . . . , produced by Trace Algorithm 2 can be further improved by applying Aitken's Δ² process repeatedly.

### Numerical Experiments

The acceleration of probing trace estimators by Aitken's Δ² process on covariance matrices with a varying degree of feature correlation is confirmed below. The experiments were conducted in a MATLAB® desktop environment (registered mark of THE MATHWORKS INC. NATICK MASSACHUSETTS USA) in 64-bit arithmetic, on a single core of a computing system equipped with a 2.3 GHz high-performance quad-core microprocessor and 64 GB of system memory.

Four different methods were compared: “a)” Trace Algorithm 1, “b)” MC trace estimator with Rademacher vector variables, “c)” Trace Algorithm 2, and “d)” a repeated application of Trace Algorithm 2 to the sequence \hat{χ}ᵢ (double Aitken). The MC trace estimator provides estimates of the form tr(A)≈1/kΣⱼ₌₁^{j=k}, where the entries of zⱼ∈ [symbol] ⁿ are ±1 with equal probability. Since the main computational cost of all four approaches listed above stems from the evaluation of MV products Azⱼ, a method more efficient than another is considered when it requires fewer MV products with matrix A to achieve the same accuracy. Moreover, the size of the test matrices was set equal to n=2,048.

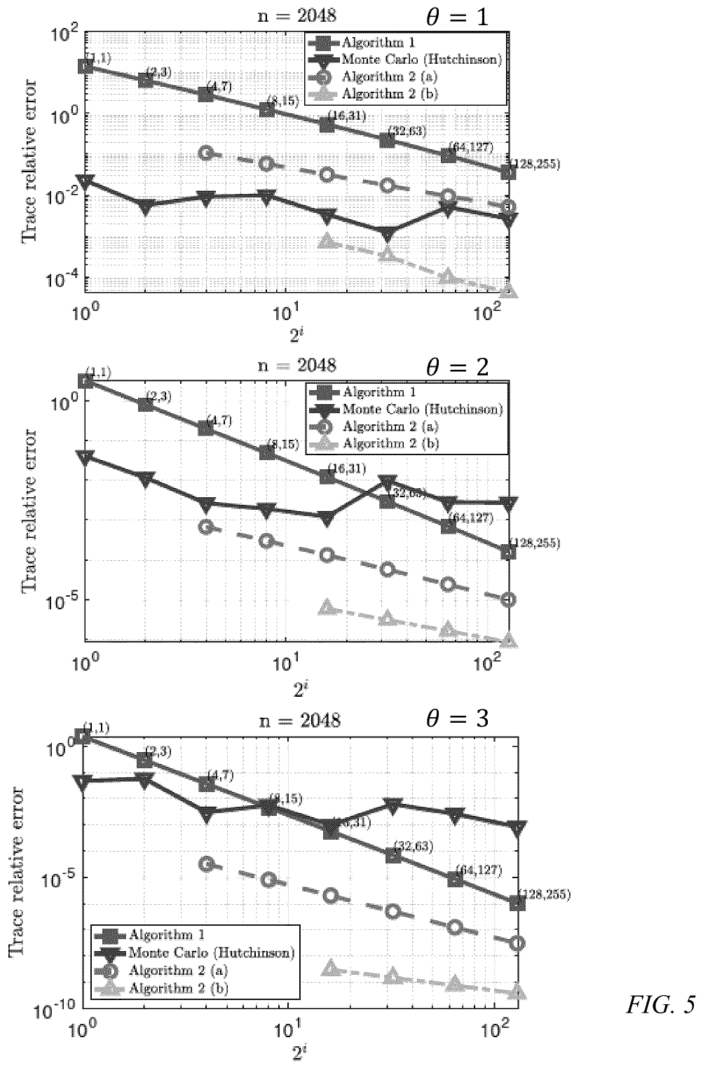

The first set of experiments considers the following class of model covariance matrices:

$$\\ \begin{matrix}A = \{ \begin{matrix}1 & if i ⩵ j \\ 1 / {\vert i - j \vert}^{θ} & if i \neq j\end{matrix} , & ( 2 )\end{matrix}$$

where θ∈ [symbol] controls the correlation of the feature space. In particular, higher values of θ imply less correlation among the variables and lead to stronger decay in the off-diagonal entries of the model covariance matrix. FIG. 5 shows a plot of the relative error achieved by the schemes “a)”-“d)” as the number of sample vectors 2ⁱ increases and 0={1, 2, 3}, in accordance with an example embodiment. Consider the following pertinent remarks. First, the accuracy of the trace estimates χ₀, χ₁, . . . , returned by the probing technique listed in Trace Algorithm 1 improves as the value of 2ⁱ increases (solid line with square data points). The pair of integers listed on top of each entry denotes the value of 2ⁱ required to compute the corresponding approximation (left integer) as well as the cumulative number 2⁰+2¹+ . . . 2ⁱ of MV products up to this point (right integer). Second, Hutchinson's MC trace estimator (solid line with inverted triangular data points) provides a better estimate of tr(A) for low values of kᵢ=₂ⁱ, as expected for matrices A which are approximately diagonally dominant. However, it converges slowly as kᵢ increases. The convergence rate of Trace Algorithm 1 can be accelerated by applying Aitken's Δ² process to the sequence {χᵢ}, as discussed in Trace Algorithm 2. This option is denoted as “Trace Algorithm 2 (a)” (dashed line with circular data points). In addition, Aitken's Δ² process can be also applied on the sequence {\hat{χ}ᵢ}, which is equivalent to double Aitken and denoted as “Trace Algorithm 2 (b)” (dashed line with right-side up triangular data points). Trace Algorithm 2 is the most efficient scheme, especially when the double-Aitken variant is exploited. For example, when θ=3, Aitken's Δ² process can provide up to five orders of magnitude improvement for as low as kᵢ=16.

The second class of test matrices originates from the Matern covariance kernel:

$$\\ \begin{matrix}ϕ ( x ) = \frac{{( \sqrt{2 v} x / ℓ )}^{v} {{K}_{v} ( \sqrt{2 v} x / ℓ )}^{v}}{{2}^{{}_{} v - 1} Γ ( v )} , & ( 3 )\end{matrix}$$

where Γ(.) is the Gamma function, Kᵥ (·) is the modified Bessel function of the second kind of order v, and v is a positive scalar that controls the smoothness of the covariance kernel. The variable [symbol] denotes the characteristic length scale. FIG. 6 shows plots of the same quantities as in FIG. 5 for a Matérn covariance kernel discretized on a 1D grid with [symbol] =7 and v=0.1, in accordance with example embodiments. Similarly, to the results for the model covariance matrices, Trace Algorithm 2 improves the probing trace estimator and can compete with the MC estimator once a sufficient number of samples is exploited.

One particular application of the above techniques is the computation of vertex centralities and top-N graph recommendation. In this setting, determining the top-N most influential nodes of a network corresponds to estimating the main diagonal of matrix functions, e.g., e^{A} and (I−αA)⁻¹, where A denotes the adjacency matrix of the input undirected graph.

Given the discussion thus far, it will be appreciated that, in general terms, an exemplary method, according to an aspect of the invention, includes the operations of: as at 254, loading, using a hardware processor, a matrix (e.g., matrix A); as at 258, computing, using the hardware processor, diagonal entry approximations for the matrix by using one or more probing vectors; as at 262, applying, using the hardware processor, an Aitken extrapolation to the diagonal entry approximations; and, as at 266, obtaining, using the hardware processor, a final diagonal estimation based on the Aitken extrapolation.

As will be appreciated by the skilled artisan, the method just set forth improves the technological process of computerized matrix diagonal estimation for a variety of practical applications, by reducing the number of central processing unit (CPU) cycles to determine a matrix diagonal estimation.

One or more embodiments further include, using the hardware processor, defining the one or more probing vectors based on an exponential function.

Referring, for example, to the diagonal estimation procedure described above, in one or more embodiments,_the matrix is designated as A and the computing of the diagonal entry approximations comprises forming a diagonal approximation d(i) by performing an element-wise multiplication of the matrix A with a matrix (VV^{T}) and subsequently performing an element-wise division with a matrix V∘V.

Further, in one or more such embodiments, the computing of the diagonal entry approximations is carried out iteratively; an i^{th} iteration defines: a scalar k as 2ⁱ−2ⁱ⁻¹, a matrix V as repmat(Iₖ, n/k, 1) %% where Iₖ is a k×k identity matrix, and the approximation d(i); and the iterations terminate when no more than log (n) iterations have been performed.

As per operation 270, one or more embodiments further include determining a trace estimate based on the final diagonal estimation. Alternatively, a trace estimate can be determined without using the final diagonal estimation; for example, using techniques as described in the “Trace estimation” section above.

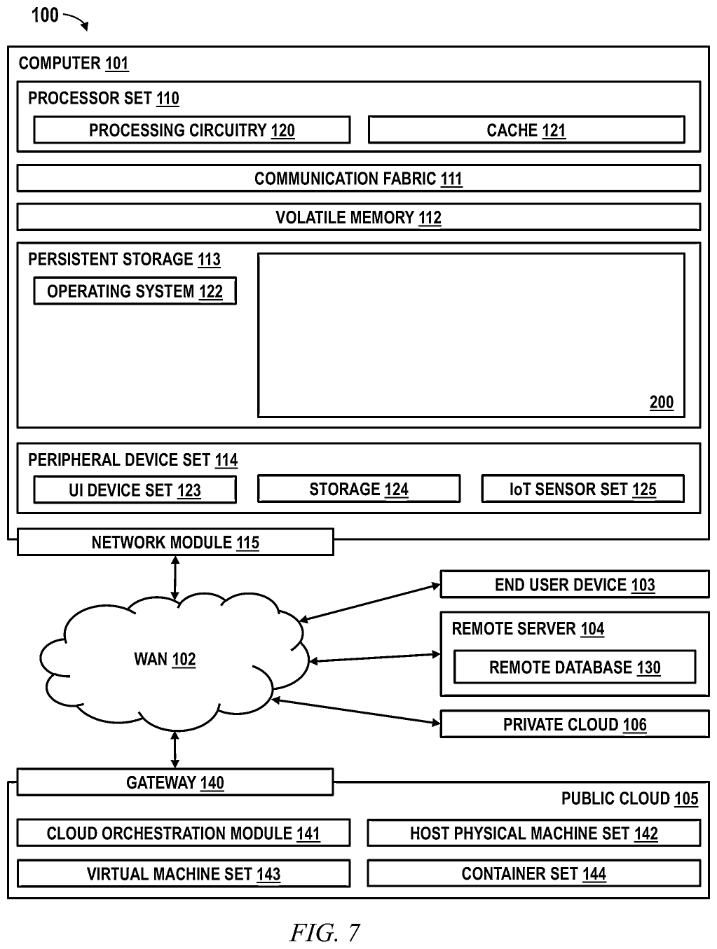

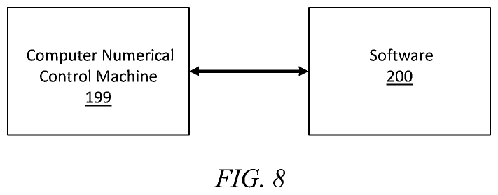

As noted, a variety of practical applications are possible. For example, in some specific instances, in the loading step (operation 254), the matrix includes a density matrix of a first alloy, and a further step includes, based on the final diagonal estimation for the first alloy, determining that the first alloy is unstable. In at least some such instances, additional steps include, based on the determination that the first alloy is unstable, reformulating the first alloy as a second, different alloy and repeating the loading, computing, applying, and obtaining steps for the second alloy; based on the final diagonal estimation for the second alloy, determining that the second alloy is stable; and, based on the determination that the second alloy is stable, specifying the second alloy. For example, responsive to the specifying, a further step includes using the hardware processor to control a machine tool to fabricate a part of the second alloy. Refer to FIGS. 7 and 8 and accompanying text.

Of course, it is possible that the first alloy analyzed is acceptable. Thus, in some specific cases, in the loading step (operation 254), the matrix includes a density matrix of a first alloy, and further steps include, based on the final diagonal estimation for the first alloy, determining that the first alloy is stable; and, based on the determination that the first alloy is stable, specifying the second alloy. For example, responsive to the specifying, a further step includes using the hardware processor to control a machine tool to fabricate a part of the first alloy. Refer to FIGS. 7 and 8 and accompanying text.

These steps can, in general, be carried out for other materials besides alloys and for properties other than stability (e.g., insulating properties); generally, for any physical property of any material that can be analyzed with matrix calculations as described herein. Thus, more generally, in some cases, in the loading step (operation 254), the matrix comprises a matrix of material properties of a first material, and a further step includes, based on the final diagonal estimation for the first material, determining that the first material is unsuitable for an application.

In some such cases, further steps include, based on the determination that the first material is unsuitable, reformulating the first material as a second, different material and repeating the loading, computing, applying, and obtaining steps for the second material; based on the final diagonal estimation for the second material, determining that the second material is suitable; and, based on the determination that the second material is suitable, specifying the second material.

Optionally, a further step includes, responsive to the specifying, using the hardware processor to control a machine tool to fabricate a part of the second material.

Again, the alloy example is but one example, such that in some cases, the first material is a first alloy and the second material is a second alloy, the matrix of material properties comprises a density matrix, and the suitability is based on stability. However, in another aspect, the first material is a first nominal insulator and the second material is a second nominal insulator, the matrix of material properties comprises a density matrix, and the suitability is based on insulating ability.

Again, in general, in some cases, in the loading step (operation 254), the matrix includes a matrix of material properties of a first material, and further steps include, based on the final diagonal estimation for the first material, determining that the first material is suitable; and, based on the determination that the first material is suitable, specifying the first material. Optionally, a further step includes, responsive to the specifying, using the hardware processor to control a machine tool to fabricate a part of the first material.

Again, the alloy example is but one example, such that in some cases, the first material is a first alloy, the matrix of material properties includes a density matrix, and the suitability is based on stability. However, in another aspect, the first material is a first nominal insulator, the matrix of material properties comprises a density matrix, and the suitability is based on insulating ability.

It should be understood that, as used herein, reference to “a” processor followed by reference to “said” processor or “the” processor contemplates one or more processors, even if “one or more” or similar language is not explicitly recited, such that a first processor might do one step and another processor coupled to the first processor might do the second step, and the two coupled processors together are to be understood as the recited processor. Thus, where a claim recites “a processor” and subsequently “the processor” or “said processor,” and a first processor does, for example, matric calculation steps, and a second processor controls a CNC machine (discussed elsewhere herein), the claim is intended to cover the two cooperating processors.

A CNC machine as discussed elsewhere herein could include, by way of example and not limitation, a milling machine, a lathe, a plasma cutter, an electric discharge machine, a multi-spindle machine, a water jet cutter, a punch press, a router, a grinder, a welder, and any type of semiconductor fabrication equipment, such as lithography equipment, cleaning, passivation, ion implantation, etching, deposition, planarization, bonding, dicing, encapsulation, plating, and the like.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 7, computing environment 100 contains an example of an environment for the execution of at least some of the computer code involved in performing the inventive methods, such as computer-aided design and manufacturing system software 200. FIG. 8 is a high-level block diagram of software controlling a CNC machine, in accordance with example embodiments. Referring to FIG. 7 and also to FIG. 8, the software 200 can be used to determine material properties as defined herein and, when desired properties have been predicted, can be used to control fabrication equipment such as a computer numerical control (CNC) machine 199 which fabricates a part out of an alloy with acceptable predictions. Software 200 can control a CNC machine using known techniques over a WAN 102 or other connection, network or direct (e.g., via cabling), wired, or wireless, and the like. For example, as discussed in the practical applications section, if a compound is determined to be unstable, the alloy may be reformulated (such as by using different percentages of different metals), retested, and utilized in a manufacturing process (via the CNC machine). In another example, a large gap in energy levels may be indicative of a good insulator; if predictions show an insufficiently good insulator, reformulation can take place and items can be manufactured accordingly (e.g., computer controlled semiconductor fabrication equipment fabricating an integrated circuit using the insulator). Of course, if the properties are acceptable for the first evaluated composition, it can be used directly in manufacturing. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110.

Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card.

Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
loading, using a hardware processor, a matrix;
computing, using the hardware processor, diagonal entry approximations for the matrix by using one or more probing vectors;
applying, using the hardware processor, an Aitken extrapolation to the diagonal entry approximations; and
obtaining, using the hardware processor, a final diagonal estimation based on the Aitken extrapolation.

2. The method of claim 1, further comprising, using the hardware processor, defining the one or more probing vectors based on an exponential function.

3. The method of claim 1, wherein the matrix is designated as A and the computing of the diagonal entry approximations comprises forming a diagonal approximation d(i) by performing an element-wise multiplication of the matrix A with a matrix (VV^{T}) and subsequently performing an element-wise division with a matrix V∘V.

4. The method of claim 3, wherein:
the computing of the diagonal entry approximations is carried out iteratively,
an i^{th} iteration defines:
a scalar k as 2ⁱ−2ⁱ⁻¹,
a matrix V as repmat(Iₖ, n/k, 1) %% where Iₖ is a k×k identity matrix, and
the approximation d(i), and
the iterations terminate when no more than log(n) iterations have been performed.

5. The method of claim 1, further comprising determining a trace estimate based on the final diagonal estimation.

6. The method of claim 1, further comprising determining a trace estimate without using the final diagonal estimation.

7. The method of claim 1, wherein, in the loading step, the matrix comprises a matrix of material properties of a first material, further comprising, based on the final diagonal estimation for the first material, determining that the first material is unsuitable for an application.

8. The method of claim 7, further comprising:
based on the determination that the first material is unsuitable, reformulating the first material as a second, different material and repeating the loading, computing, applying, and obtaining steps for the second material;
based on the final diagonal estimation for the second material, determining that the second material is suitable; and
based on the determination that the second material is suitable, specifying the second material.

9. The method of claim 8, further comprising, responsive to the specifying, using the hardware processor to control a machine tool to fabricate a part of the second material.

10. The method of claim 9, wherein the first material is a first alloy and the second material is a second alloy, the matrix of material properties comprises a density matrix, and the suitability is based on stability.

11. The method of claim 9, wherein the first material is a first nominal insulator and the second material is a second nominal insulator, the matrix of material properties comprises a density matrix, and the suitability is based on insulating ability.

12. The method of claim 1, wherein, in the loading step, the matrix comprises a matrix of material properties of a first material, further comprising:
based on the final diagonal estimation for the first material, determining that the first material is suitable; and
based on the determination that the first material is suitable, specifying the first material.

13. The method of claim 12, further comprising, responsive to the specifying, using the hardware processor to control a machine tool to fabricate a part of the first material.

14. The method of claim 13, wherein the first material is a first alloy, the matrix of material properties comprises a density matrix, and the suitability is based on stability.

15. The method of claim 13, wherein the first material is a first nominal insulator, the matrix of material properties comprises a density matrix, and the suitability is based on insulating ability.

16. A computer program product, comprising:
one or more tangible computer-readable storage media and program instructions stored on at least one of the one or more tangible computer-readable storage media, the program instructions executable by a processor, the program instructions comprising:
loading, using the processor, a matrix;
computing, using the processor, diagonal entry approximations for the matrix by using one or more probing vectors;
applying, using the processor, an Aitken extrapolation to the diagonal entry approximations; and
obtaining, using the processor, a final diagonal estimation based on the Aitken extrapolation;
wherein:
the matrix is designated as A and the computing of the diagonal entry approximations comprises forming a diagonal approximation d(i) by performing an element-wise multiplication of the matrix A with a matrix (VV^{T}) and subsequently performing an element-wise division with a matrix V∘V;
the computing of the diagonal entry approximations is carried out iteratively,
an i^{th} iteration defines:
a scalar k as 2ⁱ−2ⁱ⁻¹,
a matrix V as repmat(Iₖ, n/k, 1) %% where Iₖ is a k×k identity matrix, and
the approximation d(i), and
the iterations terminate when no more than log (n) iterations have been performed.

17. The computer program product of claim 16, wherein, in the loading step, the matrix comprises a matrix of material properties of a first material, the program instructions further comprising:
based on the final diagonal estimation for the first material, determining that the first material is suitable;
based on the determination that the first material is suitable, specifying the first material; and
responsive to the specifying, using the processor to control a machine tool to fabricate a part of the first material.

18. A system comprising:
a memory; and
at least one processor, coupled to said memory, and operative to perform operations comprising:
loading, using the at least one processor, a matrix;
computing, using the at least one processor, diagonal entry approximations for the matrix by using one or more probing vectors;
applying, using the at least one processor, an Aitken extrapolation to the diagonal entry approximations; and
obtaining, using the at least one processor, a final diagonal estimation based on the Aitken extrapolation.

19. The system of claim 18, wherein:
the matrix is designated as A and the computing of the diagonal entry approximations comprises forming a diagonal approximation d(i) by performing an element-wise multiplication of the matrix A with a matrix (VV^{T}) and subsequently performing an element-wise division with a matrix V∘V;
the computing of the diagonal entry approximations is carried out iteratively,
an i^{th} iteration defines:
a scalar k as 2ⁱ−2ⁱ⁻¹,
a matrix V as repmat(Iₖ, n/k, 1) %% where Iₖ is a k×k identity matrix, and
the approximation d(i), and
the iterations terminate when no more than log (n) iterations have been performed.

20. The system of claim 18, wherein, in the loading step, the matrix comprises a matrix of material properties of a first material, and wherein the at least one processor is further operative to perform further operations comprising:
based on the final diagonal estimation for the first material, determining that the first material is suitable;
based on the determination that the first material is suitable, specifying the first material; and
responsive to the specifying, using the at least one processor to control a machine tool to fabricate a part of the first material.
